(19) United States
(12) Patent Application Publication
(10) Pub. No.: US 2010/0265076 A1
(43) Pub. Date: Oct. 21, 2010

(54) OPTICAL TRANSMITTER MODULE AND OPTICAL BI-DIRECTIONAL MODULE WITH FUNCTION TO MONITOR TEMPERATURE INSIDE OF PACKAGE AND METHOD FOR MONITORING TEMPERATURE

(75) Inventors: Moriyasu ICHINO, Yokohama-shi (JP); Takahiro MIKI, Yokohama-shi (JP); Yoshimichi HASEGAWA, Yokohama-shi (JP); Toru UKAI, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/762,043

(22) Filed: Apr. 16, 2010

(30) Foreign Application Priority Data
Apr. 20, 2009 (JP) 2009-101930

(51) Int. Cl. G08B 17/00

(52) U.S. Cl. 340/584

(57) ABSTRACT

An optical module with a function to monitor a temperature within the package without installing any specific temperature sensing device is disclosed. The optical module of the invention includes an LD and a monitor PD in a CAN type housing. When the LD is inactive or driven under a constant bias current, the monitor PD receives a constant current independent of the temperature. The forward voltage of the monitor PD indicates the temperature within the package.

### BACKGROUND OF THE INVENTION

1. Field of the Invention

The present invention relates to an optical module, in particular, the invention relates to a transmitter optical module and a bi-directional optical module with a function to monitor a temperature inside of a package without implementing a specific temperature sensing device, and the invention relates to a method to sense a temperature inside of the package.

2. Related Prior Art

The emission of a semiconductor laser diode (hereafter denoted as LD) applied to the optical communication system strongly depends on an operating temperature, which is generally called as the temperature dependence of the I-L characteristic. An LD shows a smaller threshold current IT_{H} and a larger slope efficiency η in relatively lower temperature, while, they degrades in higher temperatures, that is, the threshold current IT_{H} increases and the slope efficiency η decreases. Accordingly, the bias current I_{b} and the modulation current Iₘ are necessary to be adjusted depending on the operating temperature of the LD to keep the optical power and the extinction ratio of the LD in constant.

In order to compensate the temperature dependence of the LD, a feedback control has been commonly used to maintain the output power and the extinction ratio, which is generally called as the auto-power control (hereafter denoted as APC). The APC circuit sometimes includes a temperature sensor, typically a thermistor, to monitor an ambient temperature of the LD arranged in a vicinity of the LD. A Japanese Patent published as JP-H06-069600 has disclosed one type of such optical transmitter module with the function to monitor the ambient temperature of the LD. Another optical module in which the temperature of the LD is positively controlled so as to keep it in constant, implements a temperature control device, typically a Peltier device, to mount the LD thereon. A thermistor is also mounted on the Peltier device on a position immediate to the LD to sense the temperature of the LD.

Moreover, recent optical module has installed both an optical transmitter device and an optical receiving device in a single package, which is often called as a bi-directional optical module. A major application of the bi-directional optical module is the passive optical network (hereafter denoted as PON) system. Architecture of the PON system results in widely varied optical input levels at the central office depending on the transmission length between respective subscribers and the central office. Because a p-i-n photodiode (hereafter denoted as PIN-PD) is hard to compensate the variation of the optical input level, the PON system often applies an avalanche photodiode (hereafter denoted as APD). The APD shows a carrier multiplication function depending on a bias condition; accordingly, the PON system may compensate the variation of the optical input level by adjusting the bias condition applied to the APD.

A package of the bi-directional module is necessary to implement lead pins for the receiver unit including the APD in addition to lead pins for the transmitter unit. Moreover, the APD generally shows larger temperature dependence in the carrier multiplication function compared to that of the PIN-PD. Thus, the system using the APD preferably controls the bias condition of the APD depending on the ambient temperature thereof. When an optical module implements a thermistor in the package thereof, further lead pins are necessary in addition to those for the transmitter unit and for the receiver unit to extract a signal from the thermistor. Conventional optical module that implements the thermistor therein uses a box-type package with a relatively larger size, which is typically called as butterfly package, where enough lead pins are prepared for the transmitter and receiver units, and for the thermistor. However, continuous request to make the package of the optical module in compact makes it hard to use the butterfly package.

### SUMMARY OF THE INVENTION

One aspect of the present invention relates to an optical module that comprises an LD to emit signal light, a monitor PD to monitor a portion of the signal light, and a CAN package to enclose the LD and the monitor PD therein. A feature of the optical module according to the present invention is that the monitor PD receives a constant current independent of an ambient temperature within the CAN package and generates a forward voltage depending on the ambient temperature within the CAN package when it is free from the monitoring of the portion of the signal light.

The optical module of the invention may further provide a constant current source, and first and second switches, they are in outside of the CAN package. The first and second switches connect an anode and a cathode of the monitor PD to the current source and to a ground, respectively, when the monitor photodiode is free from the monitoring of the portion of the signal light. While, connect the anode and the cathode of the monitor PD to the ground through a resistor and to a bias supply, respectively, when the monitor PD monitors the portion of the signal light, in which the monitor PD is reversely biased by the bias supply and the resistor.

The optical module of the invention may further include a controller that constitutes the APC loop cooperating with the monitor PD and the LD. The APC loop is suspended when the monitor PD is free from the monitoring of the portion of the signal light, and the LD becomes inactive or is driven under a constant condition independent of the ambient temperature.

The optical module of the invention may further enclose in the CAN package a receiver PD, a pre-amplifier and an optical filter. The LD may emit the signal light with the first wavelength to an external fiber, while, the receiver PD may receive another signal light with the second wavelength different from the first wavelength from the external fiber. The optical filter may reflect the signal light, while, may transmit the other signal light. The receiver PD and the pre-amplifier may be operated based on a receiver ground, while, the LD is operated based on a transmitter ground that is electrically isolated from the receiver ground. In the present optical module, the receiver PD may be operated based on the transmitter ground when it monitors the portion of the signal light, while, it may be operated based on the receiver ground when it is free from the monitoring of the portion of the signal light and receives the constant current to monitor the ambient temperature within the CAN package. The receiver PD in the present invention may be a type of avalanche photodiode (APD) variably biased based on the ambient temperature monitored by the monitor PD. The optical module thus configured to install the LD and the receiver PD in the single CAN package may be effectively applicable to the PON system.

Another aspect of the present invention relates to a method to control an optical module with a CAN package that installs an LD to emit signal light and a monitor PD to monitor portion of the signal light. The method includes steps of: (a) suspending for the monitor PD to monitor the portion of the signal light; (b) flowing a constant current independent of an ambient temperature with the CAN package in the monitor PD forwardly; (c) detecting a forward voltage of the monitor PD; and (d) calculating the ambient temperature within the CAN package based on the forward voltage of the monitor PD.

The optical module of the invention may further include a current source and the first and second switches. The method may further include a step, in suspending the monitoring of the portion of the signal light, for the first switch to connect the current source to an anode of the monitor PD and for the second switch to connect a cathode of the monitor PD to a ground. In a case where the ground includes a receiver ground and a transmitter ground, the step to connect the cathode to the ground includes a step to connect the cathode to the receiver ground, and the method may further include a step, after the calculation of the ambient temperature, for the first switch to connect the anode of the monitor PD to the transmitter ground through a resistor and for the second switch to connect the cathode of the monitor PD to a bias supply, in which the monitor PD is reversely biased by the bias supply and the resistor.

The optical module of the invention may further include an APD, a pre-amplifier and an optical filter within the CAN package effectively utilizable in the PON system. The method may further include a step of, after the calculation of the ambient temperature within the package, varying a bias voltage supplied to the APD based on the calculated ambient temperature. The method may still further include a step of, after the calculation of the ambient temperature, setting an initial condition of the APC loop based on the calculated ambient temperature, where the APC loop is constituted by the LD, the monitor PD and a controller provided outside of the CAN package.

### BRIEF DESCRIPTION OF DRAWINGS

The foregoing and other purposes, aspects and advantages will be better understood from the following detailed description of a preferred embodiment of the invention with reference to the drawings, in which:

FIG. 1 is a block diagram of an optical module with a function of the optical transmission according to the first embodiment of the present invention;

FIG. 2 shows an arrangement inside of the optical module shown in FIG. 1;

FIG. 3 shows an algorithm to change the operation mode of the optical module between the power monitoring mode and the temperature monitoring mode;

FIG. 4 schematically illustrates temperature characteristics of a junction diode, where the forward voltages, V_{FL}, V_{FM} and V_{FH}, are described for the constant current;

FIG. 5 is a block diagram of an optical module with function of the optical transmission and the optical reception in a single body according to the second embodiment of the present invention;

FIG. 6 shows an arrangement inside of the optical module shown in FIG. 5, where the cap of the CAN package is partially cut-off to view the inside of the housing;

FIG. 7 is a circuit diagram of the optical module, in particular, lead pin connections of the optical module are shown;

FIG. 8 schematically illustrates temperatures characteristics of the multiplication factor M of an avalanche photodiode (APD); and

FIG. 9 is time charts showing hand shake protocols between the central office and subscribers in the PON system.

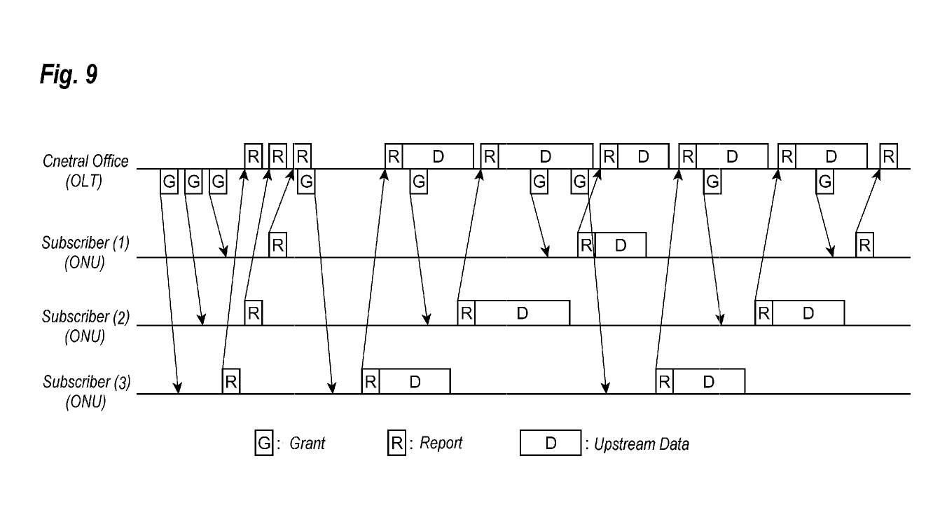

### DETAILED DESCRIPTION OF PREFERRED EMBODIMENTS

Next, preferred embodiments according to the present invention will be described as referring to accompanying drawings. In the description of the drawings, the same numerals or the symbols will refer to the same elements without overlapping explanations.

### First Embodiment

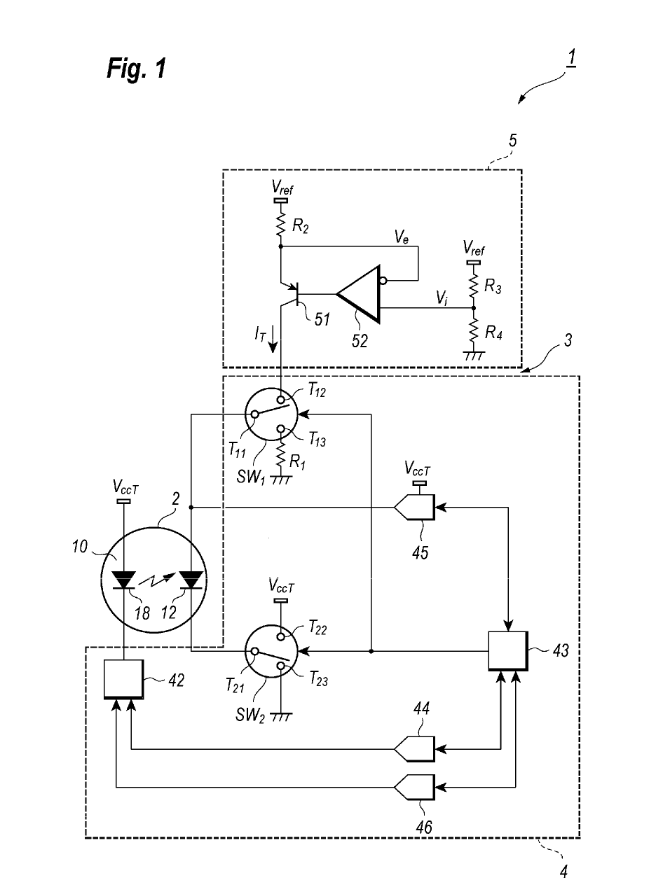

FIG. 1 is a block diagram of an optical module 1 according to an embodiment of the present invention. The optical module 1 comprises an optical assembly 2 including an optical transmitter and a circuit 3 to control the optical assembly 2. The optical transmitter has a semiconductor LD 18 and a monitor PD 12 that monitors a portion of signal light output from the LD 18, where the LD 18 and the monitor PD 12 are assembled within a CAN type package 10.

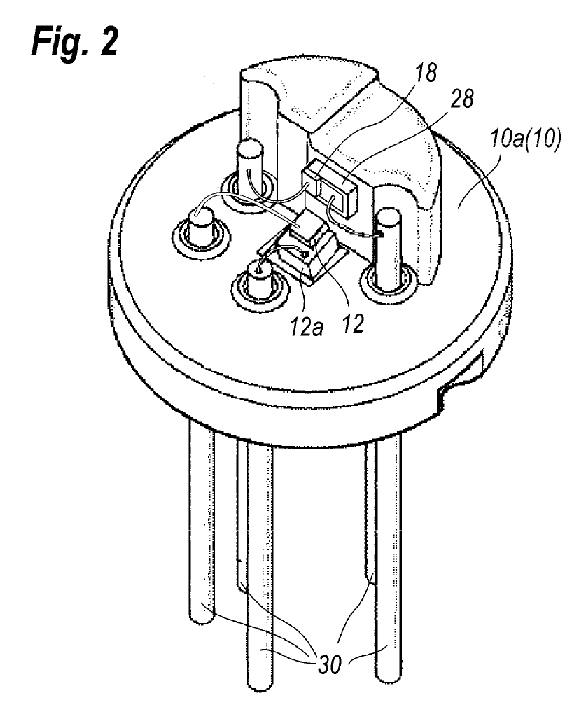

FIG. 2 illustrates a typical arrangement within the CAN package 10 of the optical assembly 2. The CAN package 10 of the optical assembly 2 includes a disk shaped stem 10a and a cap, which is not illustrated in FIG. 2, attached to a periphery of the stem 10a so as to form a space in which devices such as LD 18 and the monitor PD 12 are hermetically enclosed. On the stem 10a is assembled with the LD 18 and the monitor PD 12 through a PD sub-mount 12a so as to receive light emitted from the back facet of the LD 18. The LD is mounted in a side of the block 10b through the LD sub-mount, where the block 10b extrudes from the primary surface of the stem 10a. Thus, the optical axis of the LD 18 is substantially perpendicular to the primary surface of the stem 10a, while, the optical axis of the monitor PD 12 is inclined with a primary axis of the stem 10a which prevent the light reflected by the surface of the monitor PD 12 from returning the LD 18.

The stem 10a also provides a plurality of lead pins 30 passing therethrough to provide the ground or to transmit driving signals to the LD 18. Specifically, one of electrode, the top electrodes, of the LD 18 is directly wired to one of the lead pins 30, while, the other electrode, the bottom electrode is connected to the other lead pin through a conductive pattern on the LD sub-mount 28, on which the LD 18 is mounted. Thus, the LD 18 is provided with two signals through respective lead pins 30, which enables for the LD 18 to be driven with a differential signal. While, the top electrode of the monitor PD is directly wired to one lead pin 30, while, the bottom electrode of the monitor PD 12 is connected to another lead pin 30 through a conductive pattern on the PD sub-mount 12a, on which the monitor PD 12 is mounted.

Referring to FIG. 1 again, the circuit 3, which is externally arranged with respect to the optical assembly 2, includes a control circuit 4 that controls the optical output power of the LD 18 and calculates a temperature within the optical assembly 2; and a current source 5 that provides a constant current to the monitor PD 12. The control circuit 4 and the current source 5 are electrically coupled with the optical assembly 2 through the set of the lead pins 30.

The control circuit 4 comprises an LD driver 42 and a CPU 43 to perform the APC operation so as to keep the optical output power from the LD 18 in constant with a target power by responding the monitored signal output from the monitor PD 12. In the present embodiment, the control circuit 4 further provides two switches, SW₁ and SW₂, which change the operating mode of the monitor PD 12. The LD driver 42, which is connected to the cathode of the LD 18 and the CPU 43 through two digital-to-analog converters (hereafter denoted as D/A-C), 44 and 46, modulates the bias current provided to the LD 18 by responding the driving signal output from the CPU 43 or provided from the outside of the optical module 1. The CPU 43 is further connected to the anode of the monitor PD 12 through an analog-to-digital converter (hereafter denoted as A/D-C) 45 to sense the anode voltage of the monitor PD 12.

The second switch SW₂ is a type of the seesaw switch with three terminals, T₂₁ to T₂₃. The first terminal T₂₁ is connected to the cathode of the monitor PD 12, the second terminal T₂₂ is supplied with the power supply V_{ccT}, and the third terminal T₂₃ is connected to the ground. The second switch SW₂ may connect the cathode of the monitor PD 12 to the power supply V_{ccT} or to the ground depending on the signal provided from the CPU 43. While, the first switch SW₁ is also a type of the seesaw switch with tree terminals, T₁₁ to T₁₃. The first terminal T₁₁ is connected to the anode of the monitor PD 12, the second terminal T₁₂ receives the current output from the current source 5, and the third terminal T₁₃ is connected to the ground through a resistor R₁. The first switch SW₁ may connect the anode of the monitor PD 12 to the current source 5 or to the ground by responding the control signal same with the signal provided to the second switch SW₂.

The current source 5 includes a transistor 51, a differential amplifier 52 and resistors, R₂ to R₅. The current is output from the collector of the transistor 51 to the second terminal T₁₂ of the switch SW₁; while, the base thereof receives the output of the differential amplifier 52 and the emitter is connected to the reference V_{ref} through the resistor R₂. The non-inverting input of the differential amplifier 52 receives another reference Vᵢ which is a voltage dividing the reference V_{ref} by two resistors, R₃ and R₄. Thus, the current source 5 may operate such that the emitter voltage Vₑ of the transistor 51 becomes equal to the other reference Vᵢ by flowing the current I_{T} from the reference V_{ref} in the resistor R₂. The relation of the current I to the resistors, R₂ to R₄, is given by the equation (1) below:

$$\begin{matrix}{I}_{T} = ( {V}_{ref} - {V}_{i} ) / {R}_{2} \\ = {V}_{ref} \times ( 1 - {R}_{4} ( {R}_{3} + {R}_{4} ) ) / {R}_{2}\end{matrix} \qquad ( 1 )$$

Note that, the current I thus obtained is independent of the temperature within the optical assembly 2.

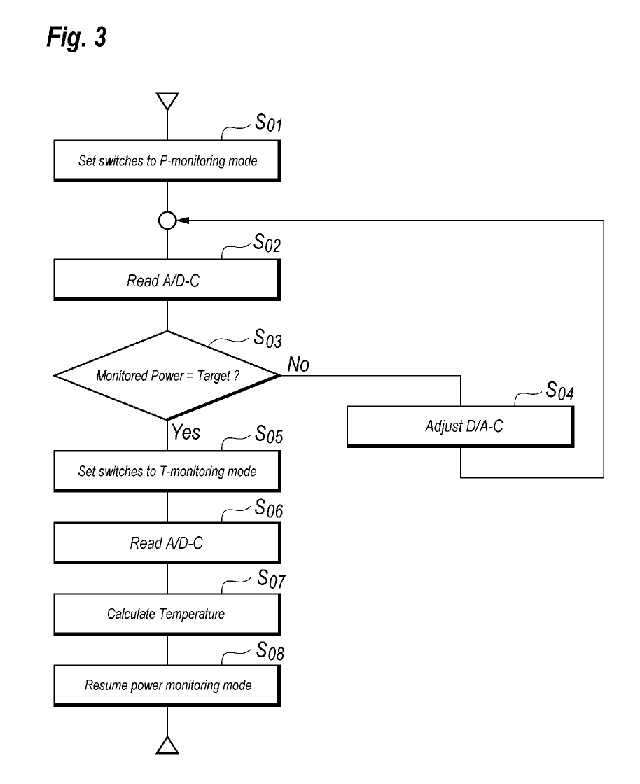

Next, a method to measure an ambient temperature within the optical assembly 2 and to control the driving current of the LD 18 will be described as referring to FIG. 3 which is a flow chart of the operation of the optical assembly 2 when the optical assembly 2 emits the signal light.

When the optical assembly 2 monitors the optical power output therefrom, the CPU 43 grounds the anode of the monitor PD 12 through the resistor R₁ by setting the first switch SW₁ so as to come the first terminal T₁₁ in contact to the third terminal T₁₃. Concurrently with the set of the first SW₁, the CPU 43 also connects the cathode of the monitor PD 12 to the bias supply V_{ccT} by setting the second switch SW₂ so as to come the first terminal T₂₁ in contact with the second terminal T₂₂, at step S₀₁, which is called as the power monitoring mode. In this arrangement around the monitor PD 12, where the cathode thereof is supplied with the bias voltage V_{ccT}, while the anode is connected to the ground through the resistor R₁, a photocurrent I_{PD} generated in the monitor PD 12 flows in the resistor R₁. The magnitude of the photocurrent I_{PD} depends on the optical power P [mW] monitored by the monitor PD 12 and the quantum efficiency η of the PD 12, that is, the photocurrent I_{PD} is determined by an equation of I_{PD}=η×P. The A/D-C 45 may convert the voltage V_{PD} (=I_{PD}×R₁) to a digital form to enable the CPU 43 to calculate the optical power output from the LD 18, at step S₀₂.

Then, the CPU 43 compares at step Sₒ₃ the present optical power detected through the A/D-C 45 with a target optical power stored within the CPU 43. When the present optical power is out of a preset range around the target power, which corresponds to the branch “No” in FIG. 3, the CPU 43 adjusts a value set in the D/A-C 44 so as to vary the present optical power close to the target power at step S₀₄. Thus, the CPU 43 carries out the APC operation by iterating the operations above described.

On the other hand, when the current optical power is equal to or within a preset range around the target optical power, which corresponds to the branch “Yes” in FIG. 3, the CPU 43 suspends the APC operation and keeps the bias current currently supplied to the LD 18 in constant at a value set in the D/A-Cs, 44 and 48, immediately before the suspension. Simultaneously, the CPU 43 connects the anode of the monitor PD 12 to the current source 5, while the cathode thereof to the ground by setting the first switch SW₂ so as to make the first terminal T₂₂ thereof in contact to the second terminal T₁₂ and the second switch SW₂ so as to make the first terminal T₂₁ in contact to the third terminal T₂₃, at step S₀₅, which is called as the temperature monitoring mode. Then, the constant current I_{T} provided from the current source 5 flows in the monitor PD 12 as the forward current. Note that the constant current I_{T} is independent of the ambient temperature within the optical assembly 2.

The forward current I_{T} flows in the monitor PD 12 results in a forward voltage V_{F} and this forward voltage V_{F} is monitored by the CPU 43 through the A/D-C 45 at step S₀₆. The forward voltage V_{F} of the monitor PD 12 is given by the equation below:

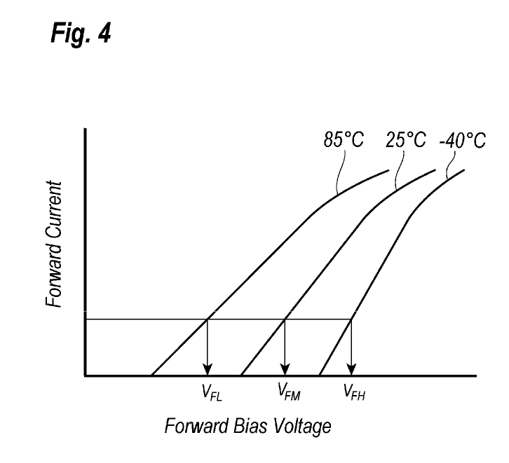

V_{F}˜n×kT/q×ln(I_{T}/I_{S}) (2),

where parameters n, k, T, q and I_{S} are an ideal factor greater than but close to unity depending on respective diodes, the Boltzmann constant, an absolute temperature of the monitor PD 12, an electric charge, and the saturation current of the diode, respectively. Because these parameters are constant or substantially independent of the temperature, the forward voltage V_{F} shows a linear dependence on the temperature T of the diode as long as the current flowing therein is kept constant. Typical temperature dependence of the forward voltage V_{F} is about −2 mV/° C. for the junction diode, which depends on semiconductor materials constituting the monitor PD 12. FIG. 4 shows a relation between the temperature and the forward voltage V_{F} of the junction diode. As shown in FIG. 4, as the temperature of the diode increases, from −40° C., 25° C. to 85° C., the forward voltage V_{F} decreases.

Because the contact resistance of terminals, T₁₁ to T₁₃, and that of terminals, T₂₁ to T₂₃, are ignorable compared to the inherent resistance of the diode, the temperature T_{MON} within the optical assembly 2 may be calculated by an equation below at step S₀₇:

T_{MON}=a×Dt+b (3),

where a and b are constant, while Dt is the output of the A/D-C 45.

At step S₀₈, the CPU 43 stops the temperature monitor mode and resumes the power monitor mode. Concurrently with the resumption of the power monitor mode, the CPU 43 resets the value of the initial bias current, which is first provided to the LD 18, to a value corresponding to the monitored temperature T_{MON} through the D/A-C 44.

Conventionally, the optical assembly, which installs an LD inherently having large temperature dependence in characteristics thereof, is inevitably requested to be operable in a wide temperature range. Accordingly, the optical assembly is necessary to be installed with a temperature sensor such as thermistor within the package, or regards a temperature sensed outside of the package as the ambient temperature within the package, which results in an insufficient compensation for the temperature dependence of the LD 18.

The optical assembly 1 according to the present embodiment senses the ambient temperature within the package 10 by the monitor PD 12 which ordinary monitors a portion of the signal light emitted from the back facet of the LD 18, and the bias current provided to the LD 18 may be adjusted based on thus sensed ambient temperature, which is unnecessary to add additional no device to sense the ambient temperature and no lead pins for extracting a signal including the ambient temperature. The LD 18 may be enough compensated for the temperature dependence thereof as keeping the size of the package in compact.

### Second Embodiment

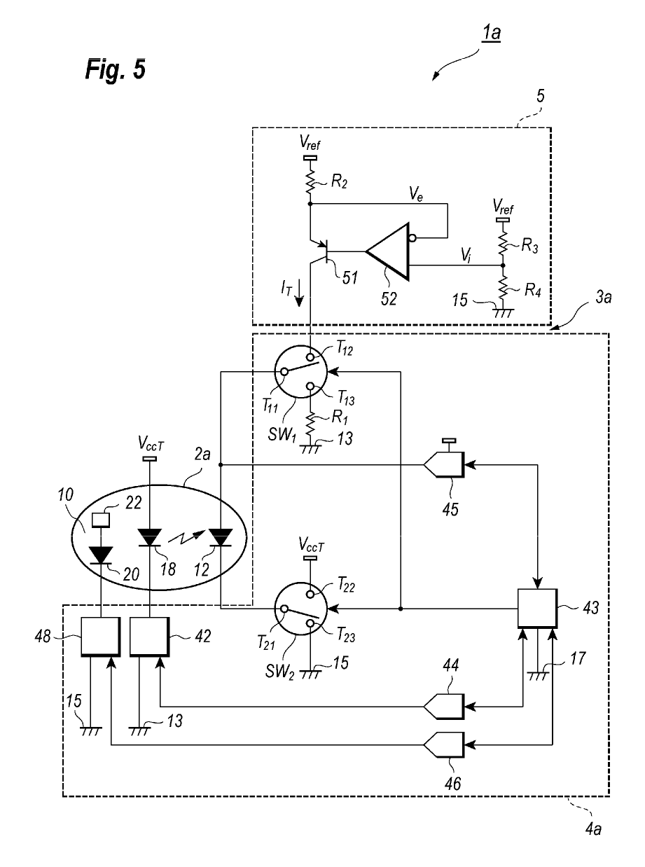

FIG. 5 illustrates a circuit diagram of an optical module 1a according to the second embodiment of the invention. The optical module shown in FIG. 5 includes, compared with the optical module 1 shown in FIG. 1, a modified optical assembly 2a and a modified control circuit 4a. The optical assembly 2a of the embodiment further includes a receiver photodiode 20 and a pre-amplifier 22 in the common package 10. The receiver PD 20 may be a type of avalanche photodiode (hereafter denoted as APD) with a carrier multiplying function, while the pre-amplifier 22 converts a photocurrent generated in the APD 20 in to a voltage signal and amplifies this voltage signal to output from the optical assembly 2a.

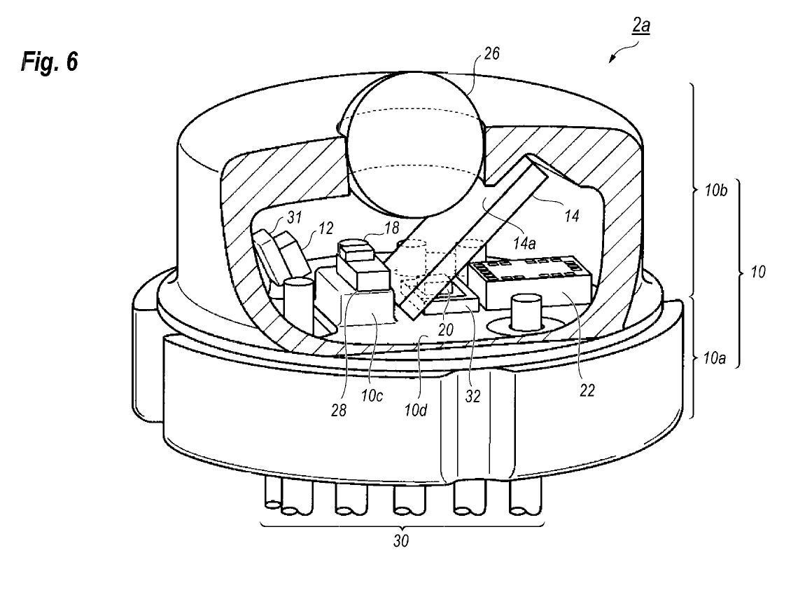

FIG. 6 illustrates the inside of the CAN package 10 of the optical assembly 2a. As shown in FIG. 2a, the CAN package includes a disk shaped stem 10a and a cap 10b attached to a periphery of the stem 10a so as to form a space in which the devices like the LD 18, the monitor PD 12 and the APD 20 are hermetically enclosed. In a ceiling of the cap 10b is provided with a lens 26 to couple the LD 18 and the APD 20 with an external fiber (not illustrated in FIG. 6). The LD 18 is mounded on a terrace 10c of the stem 10a through the LD sub-mount 28, while, the APD 20 is directly mounted in on a center of a primary surface of the stem 10a through the PD sub-mount 32. The monitor PD 12 is mounted on a tip portion of one of the lead pins 30 so as to receive the light emitted from the back facet of the LD 18. The tip portion mounting the monitor PD 12 is inclined with the primary surface of the stem 10a to prevent the light reflected by the surface of the monitor PD 12 from entering the LD 18 again.

The wavelength selective filter 14 is arranged, in a boundary between the transmitter unit that includes the LD 18 and the monitor PD 12 and the APD 20 that constitutes the receiver unit, such that the reflective surface 14a thereof makes an angle of substantially 45° against the primary surface 10d of the stem 10a. Although the optical assembly 2a supports the wavelength filter 14 by the cap 10b, an additional member with an inclined surface where the filter 14 is held may be prepared on the primary surface 10d. The optical assembly 2a may optically couples with an external fiber, which is not shown in FIG. 6, such that the external fiber is arranged in a position opposite to the filter 14 with respect to the lens 26; the LD 18 transmits the signal light with the first wavelength of, for instance 1.3 μm, to the external fiber, while, the APD 20 receives another signal light with the second wavelength different from the first wavelength, for instance 1.48 μm or 1.55 μm, provided from the external fiber. Thus, the filter 14 selectively reflects the light with the wavelength of 1.3 μm coming from the LD 18 toward the external fiber and transmits the light with the wavelength of 1.48 μm or 1.55 μm coming from the external fiber toward the APD 20. The optical assemble like the present embodiment where the optical receiver unit and the optical transmitter unit are enclosed in the single package is often called as the optical bi-directional module.

The optical assembly 2a may have two pins for providing the bias current to the LD 18, two pins for outputting the signals with the differential mode from the pre-amplifier 22, one pin for supplying the power to the pre-amplifier 22, one pin for supplying the bias for the APD 20, one pin for the ground, and two pins for the monitor PD 12. Thus, the optical assembly 2a may have total nine (9) lead pins. When the LD 18 is driven in the single phase mode, one of the lead pins for providing the bias current to the LD 18 may be common to the ground pin.

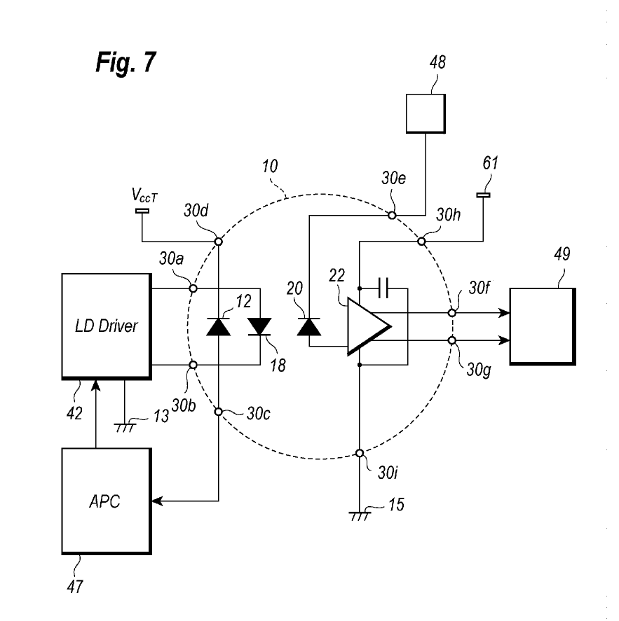

FIG. 7 shows a connection diagram of the lead pins 30 of the optical assembly 2a. The lead pins 30 include, as described above, nine pines, 30a to 30i. For the transmitter unit, the LD 18 of the present embodiment is driven by the differential signal provided from the LD driver 42. Two lead pins, 30a and 30b, are necessary to provide the differential signal which are connected to the cathode and the anode of the LD 18, respectively. The monitor PD 12 in the anode thereof is connected to the APC unit 47 that includes the A/D-C 45, the CPU 43 and the D/A-C 44 in FIG. 5. The APC unit 47 and the LD driver 42 operate based on the transmitter ground 13. The APC unit 47, as described later, may control the LD 18 so as to keep the optical output power and the extinction ratio thereof in constant.

For the receiver unit, the anode of the APD 20 is coupled with the pre-amplifier 22, while the cathode thereof is externally biased by the source 48 through the lead pin 30e. The pre-amplifier 22 converts the photocurrent coming from the APD 20 into the voltage signal with the differential mode. Two lead pins, 30f and 30g, extract this differential output to the signal processing unit 49 that is omitted in FIG. 5. The power supply for the pre-amplifier 22 is externally supplied from the source 61 through the lead pin 30h, while, it is grounded to the receiver ground 15 through the lead pin 30i.

Referring back to FIG. 5, the circuit 3, which is externally arranged to the optical assembly 2a, includes a modified control circuit 4a that controls the optical output power of the LD 18 and calculates the ambient temperature within the package 10; and a current source 5, the configuration of which is same with those shown in FIG. 1. The control circuit 4a and the current source 5 are electrically coupled with the optical assembly 2a through the set of the lead pins 30.

In the modified control circuit 4a, the ground for the receiver unit is strictly distinguished from the transmitter unit. Specifically, the third terminal T₁₃ of the first switch SW₂ is connected to the transmitter ground 13, while, the third terminal T₂₃ of the second switch SW₂ is grounded to the receiver ground 15. In the power monitoring mode where the monitor PD 12 monitors the portion of the signal light emitted from the LD 18, the SW₂ connects the first terminal T₁₁ with the third terminal T₁₃ to ground the cathode of the monitor PD 12 to the transmitter ground 13 through the first resistor R₁; and the second switch SW₂ connects the first terminal T₂₁ thereof with the second terminal T₂₂ so as to supply the bias V_{ccT} to the anode of the monitor PD 12. On the other hand, in the temperature monitoring mode, the first switch SW₁ connects the first terminal thereof T₁₁ with the second terminal T₁₂ to provide the constant current I_{T} to the anode of the monitor PD 12, while, the second switch SW₂ connects the first terminal T₂₁ thereof with the third terminal T₂₃ to ground the cathode of the monitor PD 12 to the receiver ground 15.

The bi-directional module that arranges the transmitter unit and the receiver unit within a common package has an inherent subject of the crosstalk between two units. The optical crosstalk is a mechanism that a portion of light emitted from the LD 18 becomes stray light and enters the APD 20; and a portion of the light provided from the external fiber becomes stray light and enters the LD 18 which becomes an optical noise source to disturb the quantum status within the LD 18. The latter crosstalk may be suppresses by setting the wavelength of light for the receiver unit longer than that of the transmitter unit, while, the stray light due to the emission from the LD 18 is hard to be suppressed without doing no-reflection coating to inner surfaces of the package 10.

On the other hand for the electronic crosstalk, it is caused by a switching of a large current with a high frequency signal to drive the LD 18. On the other hand, an electrical signal converted from the photocurrent generated by the APD 20 is a faint signal, typically a few milli-volts at most. This faint signal is easily influenced by the switching of the large current in the transmitter unit through two mechanisms, one of which is the electro-magnetic interference (EMI) which the switching of the large current induces a magnetic filed and this magnetic field is transferred to the receiver unit to generate am induced current; while the other of which is that the large current flows in the ground to fluctuate the ground potential that is called as the common mode noise. It would be effective to shield the receiver unit electrically from the transmitter unit in order to reduce the EMI noise. It would be also effective to distinguish the receiver ground from the transmitter ground like the present embodiment to reduce the common mode noise.

In the circuit diagram shown in FIG. 6, the transmitter ground 13 connected to the anode of the monitor PD 12 in the transmitter unit through the first switch SW₁ is directly connected to the CAN package 10. Here, the CAN package 10 is generally made of electrically conductive material, typically metal, at least the stem 10a and the cap 10b are both made of metal. On the other hand, the receiver ground 15 connected to the cathode of the monitor PD 12 through the second switch SW₂ is extracted outside of the CAN package 10 through the lead pin 30i electrically isolated from the stem 10a. The ground for the pre-amplifier 22 in the receiver unit may be common to this receiver ground 15.

An opto-electronic equipment such as optical transceiver that installs the optical module 1a of the present embodiment generally isolates the receiver ground from the transmitter ground within the housing of the equipment to reduce the electrical crosstalk within the housing, and two grounds are electrically connected in a host system that implements this electrical equipment. Accordingly, the optical module 1a preferably operates the monitor PD 12, which inherently belongs to the transmitter unit operated based on the transmitter ground 13, based on the receiver ground 15 when it is used in the temperature monitoring mode. The circuit shown in FIG. 5 illustrates the arrangement for the temperature monitoring mode. The current I_{T} generated in the current source 5 flows into the anode of the monitor PD 12 through the first switch SW₁, while, the cathode of the monitor PD 12 is directly connected to the receiver ground 15 through the second switch SW₂.

On the other hand, in the power monitoring mode, the first switch SW₁ connects the anode of the monitor PD 12 with the transmitter ground 13 through the resistor R1, and the second switch SW₂ connects the cathode of the monitor PD 12 directly to the bias supply V_{ccT}. Because the bias supply V_{ccT} is positive (V_{ccT}>0), the monitor PD 12 is reversely biased in the power monitoring mode, and the photocurrent generated in the monitor PD 12 flows in the resistor R₁ to generate a monitoring signal to be processed by the A/D-C 45. The current source 5 becomes active only in the temperature monitoring mode; accordingly, the ground for the current source 5 is set to be the receiver ground 15. The pre-amplifier 22 and the bias supply 48 are also grounded to the receiver ground 15, because they are involved in the receiver unit; while, the LD driver 42 is grounded to the transmitter ground 13.

The A/D-C 45, and D/A-Cs, 44 and 46, are generally grounded to the digital ground distinguished from the analog ground even when the crosstalk between two units is not a subject of the optical module 1a. Specifically, the digital ground is connected to the analog ground only at one point on the circuit board. The present optical module 1a makes the digital ground 17 common to the transmitter ground 13 because the digital signal also configures a large swing, for instance, an amplitude thereof becomes a few volts, which is enough large compared to the signal processed in the receiver unit. When the digital ground becomes common to the receiver ground 15, the digital signal with large amplitude strongly causes the analog signal.

The operation of the optical module 1a shown in FIG. 5 is similar to those already described as referring to FIG. 3 except for the resumption of the power monitoring mode at step S₀₈ in FIG. 5. The present optical assembly 2a implements an APD as the receiver PD 20. Generally, an APD has large temperature dependence in performances thereof although they are not comparable with those of an LD. Accordingly, the algorithm after the monitor PD 12 resumes the power monitoring mode; the CPU 43 adjusts the bias voltage supplied to the APD 20 based on the ambient temperature calculated in the temperature monitoring mode.

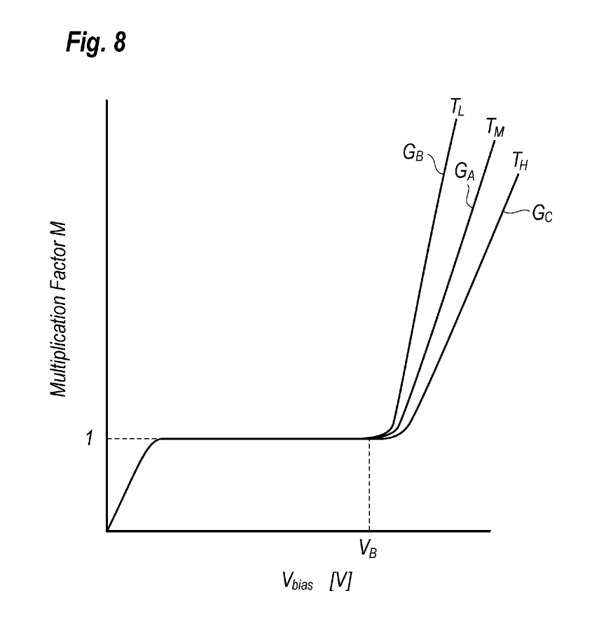

FIG. 8 schematically illustrates relations of the multiplication factor M of an APD against bias voltages V_{BIAS}. In FIG. 8, a behavior G_{A} corresponds to a characteristic when a device temperature is equal to T_{M}, a behavior G_{B} corresponds to a characteristic for a temperature of T_{L} (<T_{M}), and behavior G_{C} corresponds to a temperature of T_{H} (>T_{M}). A region where the multiplication factor M is equal to or less than unity is what is called as the PD region where the APD dose not show any carrier multiplication characteristic. While, a region where the multiplication factor is greater than unity, that is, the bias voltage V_{BIAS} is greater than V_{B}, is called as the APD region where the APD generates plural carriers for one photon.

As shown in FIG. 8, the multiplication factor M strongly depends on the device temperature. When the temperature is low, the APD shows a larger multiplication factor M for the same bias condition. Accordingly, care has to be paid for the device temperature when the APD is practically applied. When the bias voltage for an APD is set based on the multiplication factor thereof at a high temperature, thus defined bias voltage would become an excess condition for a lower temperature, which results in a large photocurrent even when an optical signal has a digital form with only high and low levels. Because an APD sometimes breaks by its own photocurrent, an appropriate bias condition is necessary to be set in the APD.

The optical communication system requests a large operating range in a temperature in spite of large temperature dependence of devices such as LD and APD used therein. Two solutions are generally utilized; one is to operate devices in a variable condition for an ambient temperature, the other one is to install a temperature control device such as Peltier device to keep the temperature of devices in constant. Both solutions are necessary to sense or to monitor the temperature of the LD and the APD. Conventional optical module arranges a temperature sensing device such as thermistor within a package to monitor the temperature of the device indirectly. For the latter case, the temperature control device installs a thermistor thereon in addition to the LD and the APD to sense the temperature of the temperature control device.

However, in a bi-directional module such as the optical module 1a according to the present invention, which installs a transmitter unit and a receiver unit in a common CAN package, it is quite hard to monitor the temperature of the LD and that of the APD independently because the LD and the APD generate unique heat independently depending on the driving condition of the LD and on the optical input level for the APD. Moreover, because of the limited space in the CAN package, a thermistor is hard to be enclosed within the package in the first place. Furthermore, even when the CAN package may enclose a thermistor therein, several lead pins are necessary to be added to extract signals from the thermistor outwardly, which enlarges the size of the CAN package.

For the bi-directional module of the embodiment, two lead pins for providing the driving current to the LD 18, a transmitter ground pin, and two lead pins for extracting the power monitoring signal from the monitor PD 12; namely, total 5 lead pins are basically necessary for the transmitter unit. Among those 5 lead pins, one of the lead pins for providing the driving current, the ground pin, and one of the lead pins for extracting the power monitoring signal may be common. In this simplified arrangement, the LD 18 is operated in a forward bias condition, while the monitor PD 12 is reversely biased; and the anode of the LD 18 and the cathode of the monitor PD 12 are commonly grounded for the ground pin. Consequently, at least three lead pins are necessary for the cathode of the LD 18, the anode of the monitor PD 12 and the transmitter ground. However, this arrangement where the transmitter unit provides three lead pins is a quite ordinary condition. When the LD 18 is necessary to be driven by the differential signal, an additional lead pin to provide the driving current to the anode of the LD 18 is inevitable. Moreover, when the monitoring PD 12 is independent of the driving unit for the LD 18 in order to process a faint monitoring signal, which is one of the target applications of the present invention, further additional lead pin is necessary for the cathode of the monitor PD 12. That is, total five lead pins are inherently necessary only for the transmitter unit.

On the other hand, the receiver unit requires a lead pin to provide the bias voltage to the APD 20 and tree lead pins for the pre-amplifier are necessary, specifically, one is for the power supply, one is for the signal output therefrom and one is for the receiver ground. When the optical module 1a is applied to a high speed optical communication system whose transmission speed reaches in giga-hertz (GHz) region and sometimes exceeds ten (10) giga-hertz, the pre-amplifier 22 has to output a differential signal, which requests one additional lead pin. Thus, the receiver unit is also necessary to provide five lead pins. Then the bi-directional optical module 1a is necessary to provide at least 3 lead pins in the transmitter unit and 5 lead pins in the receiver unit. The bi-directional module has almost no space to install another two lead pins, or at least one additional lead pin when one of two pins may be common to the ground, for the temperature sensing device. In addition, the CAN package 10 for the bi-directional mode 1a of the invention as shown in FIG. 5 has almost no space to mount any thermistor on the stem 10a.

The present bi-directional module 1a may monitor the optical output power by the monitor PD 12 to operate the LD 18 in the APC mode, and may also monitor the ambient temperature with in the package 10 by the same monitor PD 12 to control the bias voltage applied to the APD 20 to set an adequate multiplication factor thereof, without installing additional device within the CAN package 10. The temperature of the LD 18 and that of the APD 20 may be monitored in vicinity thereof without changing the arrangement including the LD 18 and the monitor PD 12. Because the temperature is monitored within the CAN package 10, the feedback control of the operating condition of the LD 18 may enhance the preciseness compared to a conventional arrangement where a thermostat is arranged outside of the CAN package 10 that elongates the heat conducting path from the LD 18 the sensor. Moreover, the temperature of the APD 20 may be also monitored in vicinity of the LD 18 where the APD 20 is influenced by the heat generated by the LD 18, which may precisely control the bias condition of the APD 20.

The bi-directional optical module 1a according to the present embodiment becomes quite useful when it is used in PON system. The PON system networks an optical line terminal (OLT) in a central office with a plurality of optical network unit (ONU) set in respective subscribers with optical fibers and passive optical branches. The downstream data from the OLT to the ONU is sent to all ONUs at once without distinguishing a specific subscriber. Each ONU that receives the downstream data from the OLT acknowledges messages sent to it by distinguishing a time slot allocated to respective ONUs independently. For the upstream data from respective ONUs to the OLT in the central office, each ONU is allowed to send data only in a time slot allocated to respective ONUs.

The optical module 1a in respective ONUs may suspend the transmitter function during a period except for the time slot allocated to itself, which means that the monitor PD 12 is also unused for the APC operation, the optical module 1a may use the monitor PD 12 in the temperature monitor mode. FIG. 8 shows time charts between the OLT in the central office and ONUs of the subscribers in the PON system.

The central office first sends grant messages G sequentially without being interrupted by upstream data, and respective subscribers send data D to the central office in response to the grant messages. Although FIG. 8 illustrates that the grant signal G is sent to respective subscribers sequentially, the central office practically sends the grant signal at one time and respective subscribers pick up a message sent to itself from the grant signal and sends an upstream data D in synchronous with the grant signal G. FIG. 8 also illustrate that the central office overlaps the transmission of the grant signal G and the reception of the upstream data D in time base, it means that the transmission and the reception are carried out in respective fibers independent to each other or carries out in a single fiber but in respective wavelengths different from each other. Referring to FIG. 8, respective subscribers inevitably secures a period during which the transmitter unit suspends; rather, a period when the transmitter unit suspends is longer than other periods when the transmitter unit becomes busy. Generally, at least five (5) micro-seconds may be secured in the PON system for suspending the transmitter unit.

Thus, the PON system intermittently allocates, by the central office, the period for transmitting the upstream data to respective subscribers. The LD 18 in the optical module 1a of respective subscribers is suspended in a period except for the allocated period described above; accordingly, the optical module 1a of the embodiment may change the operation of the monitor PD 12 from the power monitoring mode to the temperature monitoring mode during the period not allowed to send the upstream data D. Specifically, the optical module 1a suspends the APC operation in synchronous with the completion of the period allocated to itself, and resumes the APC operation in synchronous with the beginning of the period.

Because the CPU 43 in the optical module 1a controls the current source 5 so as to flow the constant current I_{T} in the monitor PD 12 intermittently during a period forbidden to transmit the upstream data, the monitor PD 12 may be operated in the temperature monitor mode to sense the temperature within the package 10 effectively during other periods forbidden to transmit the data. The receiver unit in the optical module 1a is always active even when the transmitter unit is inactive, which means that the pre-amplifier 22 is always active. That is, the temperature within the package 10 may be kept substantially constant even for the intermittent operation of the LD 18; accordingly, the temperature calculated from the forward voltage of the monitor PD 12 when the constant current I_{T} from the current source 5 flows therein may be regarded as the ambient temperature within the package 10.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An optical module, comprising
a laser diode for emitting signal light;
a monitor photodiode for monitoring portion of said signal light intermittently; and
a CAN package for enclosing said laser diode and said monitor photodiode,
wherein said monitor photodiode receives a constant current independent of an ambient temperature within said CAN package and generates a forward voltage depending on said ambient temperature when said monitor photodiode is free from said monitoring of said portion of said signal light.

2. The optical module of claim 1,
further comprising a current source, a first switch and a second switch,
wherein said current source provides said constant current to said monitor photodiode, and
wherein said first switch and said second switch connect, when said monitor photodiode is free from said monitoring of said portion of said signal light, an anode and a cathode of said monitor photodiode to said current source and to a ground, respectively, and
wherein said first switch and said second switch connect, when said monitor photodiode monitors said portion of said signal light, said anode and said cathode of said monitor photodiode to said ground through a resistor and to a bias supply, respectively.

3. The optical module of claim 2,
wherein said monitor photodiode is reversely biased by said bias supply and said resistor when said monitor photodiode monitors said portion of said signal light.

4. The optical module of claim 1,
further including a controller constituting an auto-power control loop cooperating with said monitor photodiode and said laser diode,
wherein said auto-power control loop is suspended when said monitor photodiode is free from said monitoring of said portion of said signal light, and said laser diode is inactive or driven under a constant condition independent of said ambient temperature.

5. The optical module of claim 1,
wherein said CAN package further encloses a receiver photodiode, a pre-amplifier and an optical filter, said laser diode emitting said signal light with a first wavelength to an external fiber and said receiver photodiode receiving another signal light with a second wavelength from said external fiber, said optical filter transmitting said other signal light and reflecting said signal light,
wherein said receiver photodiode and said pre-amplifier are operated based on a receiver ground, and said laser diode is operated based on a transmitter ground electrically isolated from said receiver ground, and
wherein said monitor photodiode is operated based on said transmitter ground when said monitor photodiode monitors said portion of said signal light, and operated based on said receiver ground when said monitor photodiode receives said constant current to monitor said ambient temperature within said CAN package.

6. The optical module of claim 5,
wherein said CAN package provides nine lead pins in all; two of which are connected to an anode and a cathode of said monitor photodiode, respectively; another two of which are connected to an anode and a cathode of said laser diode to provide a differential signal; another two of which are for providing a bias voltage to said receiver photodiode and a power supply to said pre-amplifier; another two of which are for extracting amplified signal from said pre-amplifier; and a last of which is for said receiver ground.

7. The optical module of claim 5,
wherein said receiver photodiode is an avalanche photodiode.

8. The optical module of claim 7,
wherein said avalanche photodiode is variably biased based on said ambient temperature monitored by said monitor photodiode.

9. The optical module of claim 5,
wherein said optical module including said laser diode and said receiver photodiode in said CAN package is applied for a passive optical network system.

10. The optical module of claim 9,
wherein said monitor photodiode monitors said ambient temperature in synchronous with a period when said optical module is forbidden to transmit upstream data.

11. A method of controlling an optical module with a CAN package that installs a laser diode for emitting signal light and a monitor photodiode for monitoring portion of said signal light, said method comprising steps of:
suspending for said monitor photodiode to monitor said portion of said signal light;
flowing a constant current in said monitor photodiode forwardly, said constant current being independent of an ambient temperature within said CAN package;
detecting a forward voltage of said monitor photodiode; and
calculating said ambient temperature within said CAN package based on said forward voltage of said monitor photodiode.

12. The method of claim 11,
wherein said optical module further comprising a current source, and first and second switches,
wherein said step to suspend to monitor said portion of said signal light includes a step for said first switch to connect said current source to an anode of said monitor photodiode and for said second switch to connect a cathode of said monitor photodiode to a ground.

13. The method of claim 12,
wherein said ground includes a receiver ground and a transmitter ground electrically isolated from said receiver ground,
wherein said step to connect said cathode of said monitor photodiode to said ground includes a step to connect said cathode to said receiver ground.

14. The method of claim 12,
further includes a step, after said calculation of said ambient temperature, for said first switch to connect said anode of said monitor photodiode to a ground through a resistor and for said second switch to connect said cathode of said monitor photodiode to a bias supply, wherein said monitor photodiode is reversely biased by said bias supply and said resistor.

15. The method of claim 14,
wherein said ground includes a receiver ground and a transmitter ground electrically isolated from said receiver ground,
wherein said step to connect said anode of said monitor photodiode to said ground includes a step to connect said anode to said transmitter ground, said monitor photodiode being reversely biased between said bias supply and said transmitter ground.

16. The method of claim 11,
wherein said optical module further includes an avalanche photodiode, a pre-amplifier and an optical filter in said CAN package, said laser diode emitting said signal light with a first wavelength to an external fiber and said avalanche photodiode receiving another signal light with a second wavelength from said external fiber, said optical filter reflecting said signal light and transmitting said other signal light,
wherein said method further includes a step of varying a bias voltage supplied to said avalanche photodiode based on said calculated ambient temperature.

17. The method of claim 11,
wherein said laser diode and said monitor photodiode constitutes a auto-power control loop combined with a controller outside of said CAN package, said auto-power control loop keeping an optical magnitude and an extinction ratio of said laser diode in constant,
wherein said method further includes a step for setting an initial condition of said auto-power control loop based on said calculated ambient temperature.
